(19) United States
(12) Patent Application Publication
(10) Pub. No.: US 2024/0409714 A1
(43) Pub. Date: Dec. 12, 2024

(54) GLYCOL COMPOSITIONS COMPRISING CHELANTS

(71) Applicant: Dow Global Technologies LLC, Midland, MI (US)

(72) Inventors: Caroline Woelfle-Gupta, Midland, MI (US); Rajat Duggal, Manvel, TX (US)

(21) Appl. No.: 18/702,085

(22) PCT Filed: Nov. 11, 2022
(86) PCT No.: PCT/US2022/049664

§ 371 Date: Apr. 17, 2024

Related U.S. Application Data
(60) Provisional application No. 63/278,116, filed on Nov. 11, 2021.

(51) Int. Cl. C08K 5/17

(52) U.S. Cl. CPC C08K 5/175; C08K 2201/018

(57) ABSTRACT

A glycol composition includes 50.000 wt % to 99.999 wt % of a glycol based on a total weight of the glycol composition; and 0.001 wt % to 5.000 wt % of a chelant based on a total weight of the glycol composition.

### BACKGROUND

### Field of the Disclosure

The present disclosure is directed to glycol compositions and more specifically to glycol compositions comprising chelants.

### Introduction

Glycols based on alkyl ethers come in a variety of forms. For example, glycols may be a low molecular weight solvent or may include polymerized moieties of the alkyl ethers (e.g., polyethylene glycol or propylene glycol). During storage, glycols may oxidize and/or undergo one or more reactions that produce impurities such as formaldehyde. For certain glycol applications, the United States Food and Drug Administration (“FDA”) has established a maximum threshold of formaldehyde formation during the glycol storage life. As such, minimizing the formaldehyde formation during the storage is important.

One or more antioxidants may be included in the glycol to prevent degradation and formaldehyde formation during storage. Different antioxidants have different modes of action. Antioxidants such as Vitamin C will act as oxygen scavengers via inactivation of singlet oxygen and elimination of molecular oxygen. Other antioxidants such as tocopherols will have an antioxidative activity via hydrogen donation to a free radical and subsequent formation of a complex between the radical and the tocopherol radical. Regardless of the antioxidant selected, the antioxidant approach focuses on elimination of oxygen or radicals that may breakdown the glycol and result in formaldehyde formation. There is a general trend in the glycols industry to move away from certain antioxidants and on to others. This presents an opportunity to utilize and develop new materials or methods to prevent the formation of impurities.

Glycols are used in a variety of applications. For example, U.S. Pat. No. 8,034,756B2 (“the '756 patent”) discloses a chelating composition suitable for low-temperature use or storage. The chelating composition of the '756 patent comprises 30 weight percent to 80 weight percent of a chelating component and 20 weight percent to 70 weight percent of a polar solvent which can glycol ethers. The chelating compound of the '756 patent is used for metal descaling. Another example of glycol usage is found in United States Patent Application Publication number 20170015946A1 (“the '946 publication”). The '946 publication discloses cleaning compositions having a surfactant, a glycol ether solvent, and a chelant that improve the removal of hydrophobic stains from hard surfaces. The '946 publication explains that the glycol ether solvent is typically present at a level of less than 10% and more preferably from 1% to 7% by weight of the composition. The '946 publication explains that the chelant is included because hard water can result in the formation of insoluble salts of fatty acids which reduce suds formation.

In view of the foregoing, it would be surprising to discover a glycol composition utilizing a chelant as the primary mechanism to resist formaldehyde formation.

### SUMMARY OF THE DISCLOSURE

The present disclosure provides a glycol composition utilizing a chelant as the primary mechanism to resist formaldehyde formation.

The inventors of the present disclosure have surprisingly discovered that the inclusion of a chelant in glycol compositions is able to reduce formaldehyde formation under accelerated testing conditions. Without being bound by theory, it is believed that the inclusion of a chelant in the glycol sequesters free metal ions that may otherwise catalyze oxidation and degradation of the glycol which generates formaldehyde. It is further surprising that glycol compositions can exhibit a greater than 75% reduction of formaldehyde by utilizing only a chelant and no antioxidants.

The present disclosure is particularly advantageous in the formation of glycol compositions.

In a first feature of the present disclosure, a glycol composition comprises 50.000 wt % to 99.999 wt % of a glycol based on a total weight of the glycol composition; and 0.001 wt % to 5.000 wt % of a chelant based on a total weight of the glycol composition.

In a second feature of the present disclosure, the glycol is 80.000 wt % to 99.999 wt % of the total weight of the glycol composition.

In a third feature of the present disclosure, the glycol is a polyalkylene oxide having a weight average molecular weight of 400 g/mol to 10,000,000 g/mol as measured according to gel permeation chromatography.

In a fourth feature of the present disclosure, the glycol is a polyalkylene oxide having a weight average molecular weight of 2,000 g/mol to 5,000 g/mol as measured according to gel permeation chromatography.

In a fifth feature of the present disclosure, the glycol is polyethylene glycol.

In a sixth feature of the present disclosure, the chelant is 0.001 wt % to 0.1 wt % of the total weight of the glycol composition.

In a seventh feature of the present disclosure, the chelant comprises one or more of ethylenediaminetetraacetic acid, citric acid, potassium citrate, sodium citrate and combinations thereof.

In an eighth feature of the present disclosure, the chelant comprises ethylenediaminetetraacetic acid.

In a ninth feature of the present disclosure, the glycol composition is free of an antioxidant.

In a tenth feature of the present disclosure, a formulation comprises water; and 0.1 wt % to 99 wt % of the glycol composition of any one of claims 1-9 based on the total weight of the formulation.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

As used herein, the term weight percent (“wt %”) designates the percentage by weight a component is of a total weight of the polymeric composition unless otherwise specified.

As used herein, Chemical Abstract Services registration numbers (“CAS #”) refer to the unique numeric identifier as most recently assigned as of the priority date of this document to a chemical compound by the Chemical Abstracts Service.

### Glycol Compositions

The present disclosure is generally directed to glycol compositions. The glycol compositions comprise a glycol and a chelant. In some examples, the glycol composition is free of antioxidants. As used herein, the term “free of” is defined to mean that the coating composition comprises 0.001 wt % or less of the material it is free of. In yet other examples, the glycol composition may comprise one or more antioxidants.

### Glycol

As highlighted above, the glycol composition comprises one or more glycols. As used herein, a glycol is defined as a chemical compound that comprises 2 or more hydroxyl groups. The glycol may be a low molecular weight compound selected from the group consisting of dipropylene glycol ethyl ether, tripropylene glycol ethyl ether, propylene glycol isopropyl ether, dipropylene glycol isopropyl ether, tripropylene glycol isopropyl ether, propylene glycol n-propyl ether, dipropylene glycol n-propyl ether, tripropylene glycol n-propyl ether, propylene glycol t-butyl ether, dipropylene glycol t-butyl ether, tripropylene glycol t-butyl ether, propylene glycol n-butyl ether, dipropylene glycol n-butyl ether, tripropylene glycol n-butyl ether, propylene glycol n-pentyl ether, propylene glycol n-hexyl ether, butylene glycol methyl ether, dibutylene glycol methyl ether, ethylene glycol n-butyl ether, ethylene glycol n-pentyl ether, ethylene glycol n-hexyl ether, ethylene glycol n-heptyl ether, ethylene glycol 2-ethylhexyl ether, diethylene glycol n-hexyl ether, propylene glycol methyl ether acetate, propylene glycol ethyl ether acetate, propylene glycol isopropyl ether acetate, propylene glycol n-propyl ether acetate, propylene glycol n-butyl ether acetate, dipropylene glycol methyl ether acetate, dipropylene glycol ethyl ether acetate, ethylene glycol n-butyl ether acetate, propylene glycol isobutyl ether, dipropylene glycol isobutyl ether, tripropylene glycol isobutyl ether, ethylene glycol t-butyl ether, ethylene glycol isobutyl ether, ethylene glycol ethyl ether acetate, ethylene glycol isobutyl ether acetate, diethylene glycol ethyl ether acetate, dipropylene glycol dimethyl ether, and diethylene glycol n-butyl ether acetate and combinations thereof.

Additionally or alternatively, the glycol may be a higher molecular weight compound that comprises a polymerized polyalkylene oxide. The polyalkylene oxide may be one or more of polyethylene oxide, polypropylene oxide, and polybutylene oxide. In such examples, the glycol may be a polyethylene glycol, polypropylene glycol, polybutylene oxide, and combinations thereof. The polyalkylene oxide glycol may have a weight average molecular weight of 400 grams per mole (“g/mol”) to 10,000,000 g/mol as measured according to gel permeation chromatography. For example, the polyalkylene oxide may have a weight average molecular weight of 400 g/mol or greater, or 500 g/mol or greater, or 1,000 g/mol or greater, or 1,500 g/mol or greater, or 2,000 g/mol or greater, or 2,500 g/mol or greater, or 3,000 g/mol or greater, or 3,500 g/mol or greater, or 4,000 g/mol or greater, or 4,500 g/mol or greater, or 5,000 g/mol or greater, or 5,500 g/mol or greater, or 6,000 g/mol or greater, or 6,500 g/mol or greater, or 7,000 g/mol or greater, or 7,500 g/mol or greater, or 8,000 g/mol or greater, or 8,500 g/mol or greater, or 9,000 g/mol or greater, or 9,500 g/mol or greater, or 10,000 g/mol or greater, or 10,500 g/mol or greater, or 11,000 g/mol or greater, or 11,500 g/mol or greater, or 12,000 g/mol or greater, or 12,500 g/mol or greater, or 13,000 g/mol or greater, or 13,500 g/mol or greater, or 14,000 g/mol or greater, or 14,500 g/mol or greater, or 15,000 g/mol or greater, or 20,000 g/mol or greater, or 40,000 g/mol or greater, or 60,000 g/mol or greater, or 80,000 g/mol or greater, or 100,000 g/mol or greater, or 500,000 g/mol or greater, or 1,000,000 g/mol or greater, or 5,000,000 g/mol or greater, while at the same time, 10,000,000 g/mol or less, or 5,000,000 g/mol or less, or 1,000,000 g/mol or less, or 500,000 g/mol or less, or 100,000 g/mol or less, or 50,000 g/mol or less, or 25,000 g/mol or less, or 20,000 g/mol or less, or 15,000 g/mol or less, or 14,500 g/mol or less, or 14,000 g/mol or less, or 13,500 g/mol or less, or 13,000 g/mol or less, or 12,500 g/mol or less, or 12,000 g/mol or less, or 11,500 g/mol or less, or 11,000 g/mol or less, or 10,500 g/mol or less, or 10,000 g/mol or less, or 9,500 g/mol or less or 9,000 g/mol or less, or 8,500 g/mol or less or 8,000 g/mol or less, or 7,500 g/mol or less or 7,000 g/mol or less, or 6,500 g/mol or less or 6,000 g/mol or less, or 5,500 g/mol or less or 5,000 g/mol or less, or 4,500 g/mol or less or 4,000 g/mol or less, or 3,500 g/mol or less or 3,000 g/mol or less, or 2,500 g/mol or less or 2,000 g/mol or less, or 1,500 g/mol or less or 1,000 g/mol or less, 500 g/mol or less as measured according to gel permeation chromatography.

The glycol composition comprises 50.000 wt % to 99.999 wt % of the glycol based on the total weight of the glycol composition. For example, the glycol composition may comprise 50.000 wt % or greater, or 55.000 wt % or greater, or 60.000 wt % or greater, or 65.000 wt % or greater, or 70.000 wt % or greater, or 75.000 wt % or greater, or 80.000 wt % or greater, or 85.000 wt % or greater, or 90.000 wt % or greater, or 95.000 wt % or greater, or 99.000 wt % or greater, or 99.070 wt % or greater, while at the same time, 99.999 wt % or less, or 95.000 wt % or less, or 90.000 wt % or less, or 85.000 wt % or less, or 80.000 wt % or less, or 75.000 wt % or less, or 70.000 wt % or less, or 65.000 wt % or less, or 60.000 wt % or less, or 55.000 wt % or less of the glycol based on the total weight of the glycol composition.

### Chelant

As used herein, a chelant is a compound that forms coordinate-covalent bonds with a metal ion to form chelates. Chelates are coordination compounds in which a central metal atom is bonded to two or more other atoms in at least one other molecule or ion, called a ligand, such that at least one heterocyclic ring is formed with the metal atom as part of each ring. Exemplary chelants that can be used in the glycol composition include ethylenediaminetetraacetic (“EDTA”) acid, citric acid, potassium citrate, sodium citrate, tetrasodium ethylene-diaminetetraacetate, tetrasodium ethylene-diaminetetraacetate, tetrasodium ethylene-diaminetetraacetate, diammonium ethylene-diaminetetraacetate, tetrasodium ethylene-diaminetetraacetate, tetrasodium ethylene-diaminetetraacetate tetrahydrate, disodium ethylene-diaminetetraacetate tetrahydrate, ethylenediaminetetraacetic acid, disodium ethylene-diaminetetraacetate dihydrate, calcium disodium ethylene-diaminetetraacetate dihydrate, pentasodium diethylenetriaminepentaacetate, pentasodium diethylene-triaminepentaacetate, trisodium n-(hydroxyethyl)-ethylenediaminetriacetate, iron disodium n-(hydroxyethyl)-ethylenediaminetriacetate, ethylenediaminetetraacetic acid and combinations thereof.

The glycol composition comprises form 0.001 wt % to 5.000 wt % of a chelant based on a total weight of the glycol composition. For example, the glycol composition may comprise 0.001 wt % or greater, or 0.010 wt % or greater, or 0.050 wt % or greater, or 0.100 wt % or greater, or 1.000 wt % or greater, 2.000 wt % or greater, 3.000 wt % or greater, 4.000 wt % or greater, while at the same time, 5.000 wt % or less, or 4.000 wt % or less, or 3.000 wt % or less, or 2.000 wt % or less, or 1.000 wt % or less, or 0.100 wt % or less, or 0.010 wt % or less of the chelant based on the total weight of the glycol composition.

### Formulation

The glycol composition may be used in one or more formulations. The formulation may be a cleaning composition, a cosmetics composition, industrial composition, a pharmaceutical, a personal care material, a food additive or other material comprising the glycol composition. The formulation comprises 0.1 wt % to 99 wt % of the glycol composition based on the total weight of the formulation. For example, the formulation may comprise 0.1 wt % or greater, or 1 wt % or greater, or 5 wt % or greater, or 10 wt % or greater, or 20 wt % or greater, or 30 wt % or greater, or 40 wt % or greater, or 50 wt % or greater, or 60 wt % or greater, or 70 wt % or greater, or 80 wt % or greater, or 90 wt % or greater, while at the same time, 99 wt % or less, or 90 wt % or less, or 80 wt % or less, or 70 wt % or less, or 60 wt % or less, or 50 wt % or less, or 40 wt % or less, or 30 wt % or less, or 20 wt % or less, or 10 wt % or less, or 1 wt % or less of the glycol composition based on the total weight of the formulation.

### Examples

### Materials

The following materials were used in the examples.

PEG is a polyethylene oxide glycol having a weight average molecular weight of 3,350 g/mol as measured according to gel permeation chromatography. The polyethylene glycol is commercially available from The Dow Chemical Company, Midland Michigan.

Chelant 1 is pure disodium EDTA dihydrate having a CAS number of 6381-92-6 and is commercially available from The Dow Chemical Company, Midland Michigan.

Chelant 2 is pure calcium chelate of the disodium salt of EDTA dihydrate having a CAS number of 23411-34-9

### Sample Preparation

The PEG was received as a powder material and combined in a glass vial with the identified chelant in the amount identified in Table 1.

TABLE 1

| | PEG | Chelant 2 | Chelant 1 |
|---|---|---|---|
| Example | (wt %) | (wt %) | (wt %) |
| CE1 | 100 | 0 | 0 |
| IE1 | 99.97 | 0.03 | 0 |
| CE2 | 99.97 | 0 | 0.03 |

Once combined, the vials were placed in an oven at 70° C. until fully melted. Once melted, the formulations were mixed for twenty minutes on an overhead mixer at 330 revolutions per minute and maintained at 65° C. After mixing, the formulations were transferred in an oven and allowed to sit for ten and twenty days at 65° C. before analysis.

### Test Method

DNPH reagent preparation: Approximately 0.1 gram (“g”) 2,4-Dinitrophenylhydrazine (“DNPH”) or 0.2 g of DNPH were added to a 50 milliliter (“mL”) volumetric flask. 20-30 mL acetonitrile (“ACN”) was added and the flask swirled to dissolve part of the DNPH. 3 mL concentrated hydrochloric acid was added to the flask and the contents sonicated until all solids were dissolved. The flask was brought up to volume with ACN and stored in an amber bottle.

Calibration: Commercially available, pre-derivatized stock solutions of formaldehyde-DNPH and acetaldehyde-DNPH were obtained from MilliporeSigma. Calibration working solutions were prepared gravimetrically by serial dilution of the stock solutions as free aldehyde equivalents. Single point calibration was used for quantitation with nominal concentrations of 0.99 parts per million (“ppm”) formaldehyde and 7.7 ppm acetaldehyde.

Test sample preparation: Samples to be tested were received as molten materials. In order to homogenize the samples, the samples were placed in an oven at 75° C. Samples took from forty-five to eighty minutes to fully liquefy, at which point they were swirled/inverted several times to homogenize. The samples were weighed out as soon as the samples were liquified, regardless of whether they were derivatized immediately, to minimize heat exposure as much as possible. The mass of a 20 mL vial with cap was recorded, the vial tared, and approximately 0.5 g of the sample added for each sample evaluated. The weight of the sample was recorded. 2 mL of ACN was added to the vial followed by 2 mL of DNPH reagent. Derivatized samples reacted at room temperature for fifteen minutes, then 6 mL of ACN was added, and the final mass of the vial (with cap) was recorded. The samples were analyzed within one hour of derivatization as PEG left in the reagent solution for an extended period (i.e., greater than about 2-3 hours) generates aldehydes and false positive artifacts. Table 2 provides the conditions used on an Agilent 1260 liquid chromatograph with quaternary pump, thermostated column compartment, and diode array detector to test the samples.

TABLE 2

| Column | Agilent XDB C8 (3.0 mm × 150 mm × 3.5 μm) | | | |
|---|---|---|---|---|
| Analysis Time | 16 minutes | | | |
| Post Time | 5 minutes | | | |
| Injection Volume | 5 μL | | | |
| Flow Rate | 0.65 mL/minute | | | |
| Column Temp. | 30° C. | | | |
| | | Wavelength | Reference | Bandwidth |
| | Cell | (nm) | (nm) | (nm) |
| Detector Parameters | 10 mm | 365 | none | 8 |
| | Time | | | |

| | (minutes) | % A (H₂O) | % B(CAN) |
|---|---|---|---|
| Gradient | 0 | 50 | 50 |
| | 11 | 0 | 100 |

### Results

Table 3 provides the results of the testing.

TABLE 3

| | 10 day | Standard | 20 day | Standard |
|---|---|---|---|---|
| | Formaldehyde | Deviation | Formaldehyde | Deviation |
| Example | (ppm) | (ppm) | (ppm) | (ppm) |
| CE1 | 81.30 | 1.5 | 102.00 | 3.6 |
| IE1 | 18.14 | 0.46 | 37.46 | 0.37 |
| IE2 | 20.60 | 14.70 | 35.14 | 13.52 |

Referring now to Table 3, CE1 establishes a base line for formaldehyde generation in the PEG as a result of the heat aging. IE1 and IE2 demonstrate that the addition of the different chelants is able to reduce the formaldehyde formation by greater than 75% relative to the comparative example. As explained above, such a result is surprising in that the chelant is able to drastically reduce the formation of formaldehyde despite chelants having no intrinsic antioxidant ability. Further surprising is that despite the lack of any antioxidants, which are traditionally used to prevent formaldehyde formation, the chelant is solely able to reduce the formaldehyde formation by greater than 75%.

1. A glycol composition, comprising:
50.000 wt % to 99.999 wt % of a glycol based on a total weight of the glycol composition; and
0.001 wt % to 5.000 wt % of a chelant based on a total weight of the glycol composition, the chelant comprising one or more selected from a group consisting of ethylenediaminetetraacetic acid, citric acid, potassium citrate, and sodium citrate.

2. The glycol composition of claim 1, wherein the glycol is 80.000 wt % to 99.999 wt % of the total weight of the glycol composition.

3. The glycol composition of claim 1, wherein the glycol is a polyalkylene oxide having a weight average molecular weight of 400 g/mol to 10,000,000 g/mol as measured according to gel permeation chromatography.

4. The glycol composition of claim 3, wherein the glycol is a polyalkylene oxide having a weight average molecular weight of 2,000 g/mol to 5,000 g/mol as measured according to gel permeation chromatography.

5. The glycol composition of claim 1, wherein the glycol is polyethylene glycol.

6. The glycol composition of claim 1, wherein the chelant is 0.001 wt % to 0.1 wt % of the total weight of the glycol composition.

7. (canceled)

8. The glycol composition of claim 7, wherein the chelant comprises ethylenediaminetetraacetic acid.

9. The glycol composition of claim 1, wherein the glycol composition is free of an antioxidant.

10. A formulation, comprising:
water; and
0.1 wt % to 99 wt % of the glycol composition of any one of claims 1-9 based on the total weight of the formulation.

11. A method, comprising:
adding to a glycol composition 0.001 wt % to 5.000 wt % of a chelant,
wherein the chelant comprises one or more selected from a group consisting of ethylenediaminetetraacetic acid, citric acid, potassium citrate, and sodium citrate;
wherein the chelant reduces the formation of formaldehyde by at least 75% relative to a glycol composition without the chelant.
